(19) United States
(12) Patent Application Publication
(10) Pub. No.: US 2006/0152472 A1
(43) Pub. Date: Jul. 13, 2006

(54) Display and method for driving same

(75) Inventors: Seiji Nishiyama, Hirakata-shi (JP); Naohide Wakita, Osaka-shi (JP)

Correspondence Address: PANASONIC PATENT CENTER;c/o MCDERMOTT WILL & EMERY LLP, 600 13TH STREET, NW, WASHINGTON, DC, 20005-3096, US

(73) Assignee: MATSUSHITA ELECTRIC INDUSTRIAL CO., LTD., Osaka (JP)

(21) Appl. No.: 10/534,912

(22) PCT Filed: Nov. 17, 2003
(86) PCT No.: PCT/JP03/14558

§ 371 Date: Sep. 21, 2005

(30) Foreign Application Priority Data
Nov. 15, 2002 (JP) 2002-331902
Aug. 5, 2003 (JP) 2003-286654

(51) Int. Cl. G09G 3/34

(52) U.S. Cl. 345/107

(57) ABSTRACT

A display device (1) according to this invention includes a pair of opposite substrates (3A) and (3B), a group of electrostatically chargeable colored particles (6) present between the pair of substrates, a transparent first electrode (4), and a second electrode (5), wherein the group of colored particles is capable of traveling in a manner to or not to shut off light incident on or passing through the first electrode in accordance with voltage applied across the first and second electrodes for displaying an image.

### TECHNICAL FIELD

The present invention relates to a display device for image display and a driving method thereof and, more particularly, to a display device configured to cause particulate material to travel between electrodes thereby to display images and a driving method thereof.

### BACKGROUND ART

In these years, particulate material utilizing displays configured to cause fine particles to travel between electrodes thereby to display images have been widely used as image display devices to be incorporated in image equipment such as information processing equipment or image processing equipment.

Conventional particulate material utilizing displays (electronic paper or the like for example) rely upon such image display techniques as rotation of colored particles and electrophoresis. These image display techniques realize image display by utilizing the difference in extraneous light reflection between a colored particle and an organic solvent or the like around the colored particle.

Among such conventional image display devices utilizing electrophoresis, there has been proposed, for example, an electrophoretic display device configured to display images based on migration of electrophoretically migratory particles between electrodes in a liquid phase filling the gap between a pair of opposite substrate. Since such an electrophoretic display device uses fine electrophoretically migratory particles for image display, the device can have a thin and flexible structure.

In use of the aforementioned electrophoretic display device, however, the liquid exhibits high resistance to migration of electrophoretically migratory particles in the liquid phase and, hence, the device involves a problem of slow response in image display. In attempt to enhance the speed of response in image display, a display device has been proposed which is configured to display images by causing particles to travel in a gaseous phase provided between a pair of opposite substrates. Such a display device in which particles travel in a gaseous phase can offer faster response than the aforementioned electrophoretic display device. Presently, the response time of electrophoretically migratory particles in the electrophoretic display device is about 100 msec, whereas that of particles in the image display device in which particles travel in a gaseous phase is 1 msec or less.

Here, description is made of an exemplary image display device of the type causing particles to travel in a gaseous phase for image display.

FIG. 12 schematically illustrates the construction and operating principle of a conventional image display device configured to display images by causing particles to travel in a gaseous phase. As illustrated in FIG. 12, the conventional image display device 34 includes a first substrate 36 allowing light to pass therethrough, a second substrate 35 positioned opposite to the first substrate 36, and first particles 39 and second particles 40 which are colored different from each other and encapsulated between the first and second substrates 36 and 35. The first substrate 36 is formed with an electrode 38 on its surface facing the second substrate 35 and, while the second substrates 35 formed with an electrode 37 on its surface facing the first substrate 36. Here, the first particles 39 are positively charged and the second particles 40 negatively charged.

In the conventional display device 34 thus constructed, when voltage is applied across the electrodes 37 and 38 in accordance with a video signal as shown in FIG. 12(a), the first particles 39 and the second particles 40 are caused to travel toward the first substrate 36 and the second substrate 35, respectively. In this case, if the first particles 39 and the second particles 40 are colored black and white, respectively, black display is observed from the first substrate 36 side. On the other hand, when voltage having a reversed polarity is applied across the electrodes 37 and 38 as shown in FIG. 12(b), the first particles 39 and the second particles 40 are caused to travel toward the second substrate 35 and the first substrate 36, respectively. In this case, white display is observed from the first substrate 36 side. By thus switching the polarity of voltage to be applied across the electrodes 37 and 38, the conventional image display device 34 displays black and white thereby making it possible to display a desired image.

Such a conventional display construction using particles, however, raises a problem that the device offers satisfactory visibility only in an environment with extraneous light while suffering from lowered visibility in an environment with insufficient extraneous light. That is, the conventional display construction involves the problem that it suffers from considerably degraded visibility in a dark environment such as nighttime. It is conceivable to employ a configuration using color filters for color display. However, this configuration raises a problem that the visibility lowers due to environmental light in image display within a satisfactory color reproducible range. That is, the problem is such that as the color reproducible range is enlarged, an image displayed under a condition with poor environmental light becomes darker. To obviate this problem, a color display method can be employed which uses particles colored red (R), green (G) and blue (B). This method has difficulties in differently coloring and distributing the particles for respective of R, G and B pixels.

Also, the aforementioned conventional image display device construction configured to cause particles to travel in a gaseous phase for image display needs to have a very thick layer of white particles in order to display sufficiently bright white based on reflection of light incident on the device. For this reason, the image display device has problems that higher driving voltage is needed and that the resolution of an image displayed is lowered. If the layer of white particles is made thinner to avoid these problems, another problem arises that the white color becomes dark and, particularly in a dark room such as an indoor place during nighttime, the white display becomes difficult to view. In color display, use of the configuration employing color filters or the configuration using differently colored particles is possible as described above, these configurations suffer from lowered reflectance and hence has a difficulty in reproduction of bright colors.

### DISCLOSURE OF INVENTION

The present invention has been made to solve the foregoing problems, and an object of the present invention is to provide a particulate material utilizing display device which offers a satisfactory color reproducible range without its visibility being degraded even in a dark environment with poor extraneous light, and a driving method thereof.

To attain this object, a display device according to the present invention includes a pair of opposite substrates, a group of electrostatically chargeable colored particles present between the pair of substrates, a transparent first electrode, and a second electrode, wherein the group of colored particles is capable of traveling in a manner to or not to shut off light incident on or passing through the first electrode in accordance with voltage applied across the first and second electrodes for displaying an image. Such a construction is capable of obtaining an image which is satisfactory in display quality and visibility.

This display device has a light source for emitting light. With such a feature, it is possible to obtain an image having satisfactory visibility even in an environment with poor extraneous light.

The group of colored particles is capable of traveling in a plan view in a manner to or not to shut off the light. With such a feature, it is possible to obtain an image which has satisfactory display quality and can be changed quickly.

The display device has a color filter operative to permit light from the light source to pass therethrough for color display. Such a feature can implement color display by a simplified structure.

The color filter is disposed on a surface of at least one of the pair of substrates. Alternatively, the color filter is disposed on a surface of the first electrode. Further alternatively, the color filter is disposed on a light exit surface of the light source. Such a feature can implement bright color display with satisfactory visibility by a simplified structure.

The light source is configured to emit any one of red light, green light and blue light on a time-sharing basis. Such a feature can provide for color image display having satisfactory visibility without the need to provide the color filter.

The light source is configured to emit light only for color display. Such a feature can provide for bright color display with satisfactory visibility while implementing a display device requiring low power consumption.

At least one of the pair of substrates comprises a resin film. Such a feature can implement a thin and light display device in the form of a sheet.

The display device has a reflective plate for reflecting light which is operative to reflect incident extraneous light for displaying white. Such a feature can realize clear white display in an environment with rich extraneous light by a simplified structure.

The reflective plate has a light scattering property. Such a feature can provide for clear white display.

The pair of substrates are both transparent; one of the substrates has an inwardly oriented surface formed with a projecting-depressed member defining a depression and a pair of projections on opposite sides of the depression; and the first electrode is formed on a bottom portion of the depression, while the second electrode formed on top portions of the pair of projections. Such a feature allows the colored particles to be piled up on the first electrode and hence can provide for image display with good contrast.

The projections and the pair of depressions define border portions therebetween, each of the border portions being shaped into a sloped surface; a surface extending from the sloped surface to the top portion of each of the projections is formed with a light reflective plate; and the second electrode is formed on the light reflective plate. Such a feature allows incident extraneous light to be externally reflected efficiently and, hence, clear white display can be obtained.

The second electrode is formed on the reflective plate with an insulator intervening therebetween. Such a feature prevents the reflective plate from being applied with voltage that is applied to the second electrode and hence allows the group of colored particles to gather on the second electrode.

The pair of substrates define therebetween a space in a gaseous phase. Such a feature allows the colored particles to travel with a reduced resistance, hence, at an increased speed.

A display device driving method according to the present invention is a method of driving a display device including a pair of opposite substrates, a group of electrostatically chargeable colored particles present between the pair of substrates, a transparent first electrode, and a second electrode, the method including applying voltage across the first and second electrodes to cause the group of colored particles to travel in a manner to or not to shut off light incident on or passing through the first electrode in accordance with the applied voltage for displaying an image. This method is capable of obtaining an image which is satisfactory in display quality and visibility.

A display device according to the present invention includes a pair of opposite substrates, a group of electrostatically chargeable colored particles present between the pair of substrates, a first electrode, a second electrode, and a group of transparent particles present together with the group of colored particles between the pair of substrate, the group of transparent particles being electrostatically chargeable to have a polarity opposite to that of the colored particles, wherein the group of colored particles and the group of transparent particles are capable of traveling between the first and second electrodes so as to transpose each other in a manner to or not to shut off light incident on or passing through the first electrode in accordance with voltage applied across the first and second electrodes for displaying an image. Such a construction allows the group of transparent particles and the group of colored particles to be separated from each other satisfactorily and hence is capable of obtaining an image which is satisfactory in display quality and visibility.

In this case the first electrode may be transparent. Such a feature can provide for clear white display in an environment with rich extraneous light by a simplified structure since the first electrode is transparent.

The group of colored particles and the group of transparent particles are capable of traveling so as to be displaced in a plan view in a manner to or not to shut off the light. With such a feature, it is possible to obtain an image which has satisfactory display quality and can be changed quickly.

When the group of transparent particles occupies substantially an entire area of a pixel in a plan view, a reflective member located behind the group of transparent particles reflects extraneous light to display white. Such a feature can provide for clear white display in an environment with rich extraneous light by a simplified structure.

In this case, the first electrode may comprise the reflective member. Such a feature allows the structure of the display device to be simplified since the reflective member is utilized as the first electrode.

When the group of transparent particles occupies substantially an entire area of a pixel in a plan view while occupying a major plane of the pixel, a reflective plate located behind the light source or a scattering plate located in front of the light source reflects extraneous light to display white. Such a feature can provide for clear white display in an environment with rich extraneous light by a relatively simple structure.

The pair of substrates are both transparent; the first electrode in a film form, an insulating film and the second electrode in a film form and having an opening are positioned in this order between the pair of transparent substrates; and the group of colored particles and the group of transparent particles are encapsulated in the opening of the second electrode. With such a feature, the group of colored particles and the group of transparent particles are encapsulated so as to be travelable between the first and second electrodes.

The insulating film is a color filter. Such a feature can provide for color display by a simple structure since the insulating film is the color filter.

The display device has a light source for emitting the light which is located externally of the substrate positioned closer to the first electrode. With such a feature, it is possible to obtain an image having satisfactory visibility even in an environment with poor extraneous light.

Each of the transparent particles has a larger diameter than each of the colored particles.

The display device driving method according to the present invention is a method of driving the display device further comprising a group of transparent particles present together with the group of colored particles between the pair of substrates, the group of transparent particles being electrostatically chargeable to have a polarity opposite to that of the colored particles, the method including applying voltage across the first and second electrodes to cause the group of colored particles and the group of transparent particles to travel between the first and second electrodes so as to transpose each other in a manner to or not to shut off light incident on or passing through the first electrode in accordance with the applied voltage for displaying an image. Such a method allows the group of transparent particles and the group of colored particles to be separated from each other satisfactorily and hence is capable of obtaining an image which is satisfactory in display quality and visibility.

The foregoing and other objects, features and advantages of the present invention will become apparent from the following detailed description of the preferred embodiments to be read in connection with the accompanying drawings.

### BRIEF DESCRIPTION OF DRAWINGS

FIG. 1 is a sectional view schematically showing the construction of a display device according to embodiment 1 of the present invention.

FIGS. 2(a) to 2(g) are sectional views schematically illustrating process steps included in a fabrication method of the display device according to embodiment 1 of the present invention.

FIGS. 3(a) and 3(b) are schematic views illustrating a principle of operating a pixel of the display device according to the embodiment.

FIGS. 4(a) and 4(b) are schematic views illustrating another principle of operating a pixel of the display device according to embodiment 1 of the present invention.

FIG. 5 is a sectional view schematically showing the construction of a display device according to embodiment 2 of the present invention.

FIG. 6 is a sectional view schematically showing the construction of a first variation of the display device according to embodiment 2 of the present invention.

FIG. 7 is a sectional view schematically showing the construction of a second variation of the display device according to embodiment 2 of the present invention.

FIG. 8 is a block diagram schematically showing the configuration of a display device according to embodiment 3 of the present invention.

FIG. 9 is a fragmentary plan view schematically showing in a plan view a structure of a display section included in the display device shown in FIG. 8.

FIG. 10 is a fragmentary sectional view, taken along line XX-XX of FIG. 9, schematically showing a sectional structure of the display section included in the display device shown in FIG. 8.

FIG. 11 is a driving waveform chart schematically showing driving waveforms for driving the display device according to embodiment 3 of the present invention.

FIG. 12 schematically illustrates the construction and operating principle of a conventional image display device configured to display images by causing particles to travel in a gaseous phase.

### BEST MODE FOR CARRYING OUT THE INVENTION

Hereinafter, embodiments of the present invention will be described with reference to the drawings.

### Embodiment 1

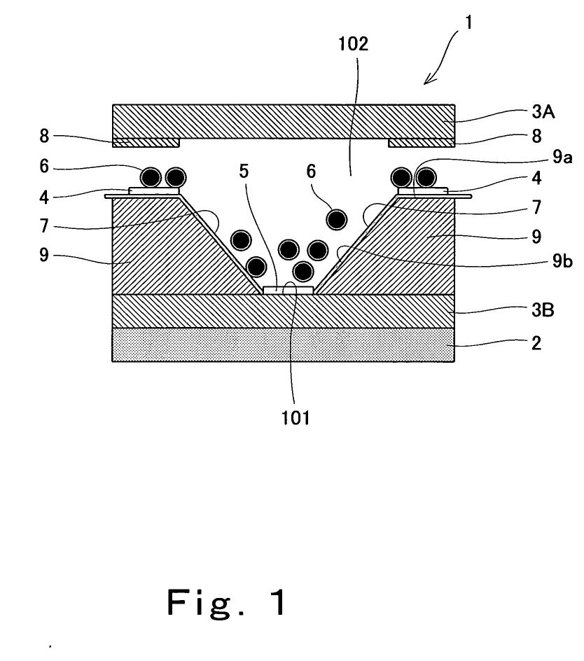

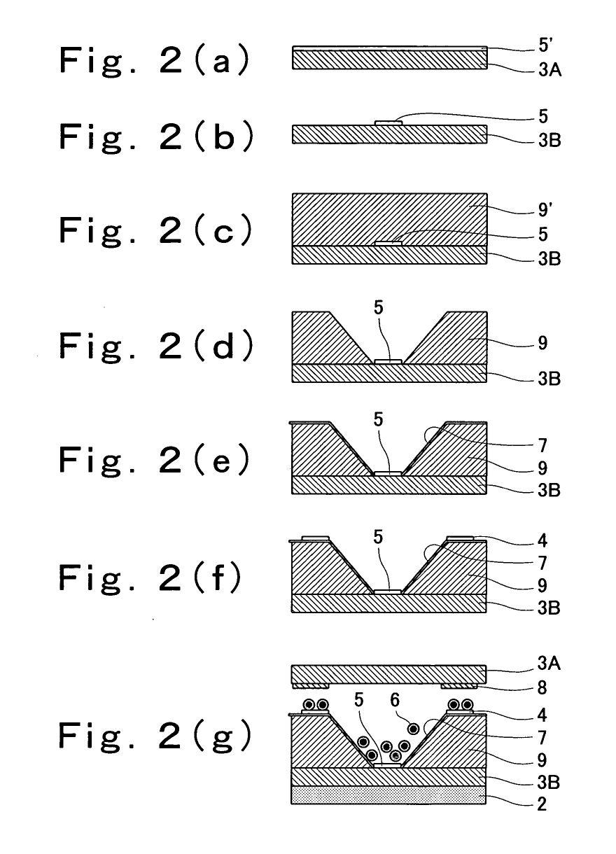

FIG. 1 is a sectional view schematically showing the construction of a display device according to embodiment 1 of the present invention; and FIGS. 2(a) to 2(g) are sectional views schematically illustrating process steps included in a fabrication method of the display device according to embodiment 1 of the present invention.

The display device according to the present embodiment has one pixel. A display device having plural pixels will be described later in the description of embodiment 4.

As shown in FIG. 1, display device 1 according to the present embodiment includes a transparent front substrate 3A and a transparent rear substrate 3B, which are positioned to face each other. The transparent substrates 3A and 3B each comprise a transparent resin substrate for example. The transparent rear substrate 3B has an inwardly oriented surface formed with a pair of uneven members 9,9. In this embodiment, each uneven member 9 is formed to have a trapezoidal section with a flat top surface 9a and a sloped surface 9b, and the two uneven members 9 are positioned opposite to each other to define fixed spacing therebetween. The uneven members 9 are formed from photoresist for example. The top surface 9a and sloped surface 9b of each uneven member 9 are each formed with a reflective film 7. The reflective film 7 comprises an aluminum film for example. A light blocking electrode 4 comprising aluminum is formed on a portion of the reflective film 7 situated on the top surface 9a of each uneven member 9. On the other hand, a transparent electrode 5 comprising ITO is formed on an inner surface 101 of the transparent rear substrate 3B which is exposed between the pair of uneven members 9,9. The transparent front substrate 3A has an inner surface on which a light blocking member (black matrix) 8 is formed via a non-illustrated intervening insulating film at a portion facing the light blocking electrode 4. The transparent front substrate 3A and transparent rear substrate 3B, which are thus formed with their respective elements, define therebetween a space 102 (hereinafter will be referred to as pixel space) in which electrostatically chargeable colored fine particles 6 are accommodated. Here, the pixel space 102 is filled with air and sealed with a non-illustrated sealing member. Thus, the colored fine particles 6 are encapsulated in the pixel space 102. In the present embodiment, the colored fine particles 6 comprise polymerized toner having a particle diameter of about 5 μm.

A backlight 2 is disposed behind the transparent rear substrate 3B. The backlight 2 is an EL backlight for example. The backlight 2 presents a substantially white outward appearance and is a surface-emitting type light source adapted to emit white light when applied with voltage.

A fabrication method of the display device 1 thus constructed will be described with reference to FIGS. 2(a) to 2(g).

Firstly, a transparent electrode film 5′ (of ITO for example) as a precursor of the transparent electrode 5 is formed to a thickness of 100 nm on a surface of the transparent rear substrate 3A by sputtering (FIG. 2(a)). The transparent electrode film 5′ is then patterned into a predetermined shape using photoresist or the like, thus forming the transparent electrode 5 (FIG. 2(b)). Actually, the transparent electrode 5 was formed by patterning an ITO film to have a width of 10 μm and a length of 50 μm. After the formation of the transparent electrode 5, the transparent electrode 5 and the transparent rear substrate 3B are coated with positive type resist (for example “PMER” produced by TOKYO OHKA KOGYO CO., LTD.) to a thickness of about 25 μm, thus forming a resist film 9′ as a precursor of the uneven members 9 (FIG. 2(c)). Subsequently, the resist film 9′ is patterned by photolithography using a mask having an opening at a position coinciding with the transparent electrode 5. Thus, an opening (not shown) is formed at a portion of the resist film 9′ lying above the transparent electrode 5. In turn, the resist film 9′ on the transparent rear electrode 3B is rendered fluidized by heating with a hot plate under the heating conditions: 130° C. and 120 seconds, to form the uneven members 9 having a predetermined shape (FIG. 2(d)). Then, the resulting structure is subjected to post-baking in an oven under the heating conditions: 220° C. and 60 minutes. After the uneven members 9 have been formed on the transparent rear substrate 3B, the reflective film 7 comprising aluminum is formed as a light reflective plate on the surface of the uneven members 9 (FIG. 2(e)). In this case the reflective film 7 is formed so as not to become electrically short-circuited with the transparent electrode 5. For improving the whiteness of white display of the display device 1, it is desired that the reflective film 7 have an uneven surface. Subsequently, photolithography is conducted to form the light blocking electrode 4 on the reflective film 7 lying on the top surface of each uneven member 9 at a predetermined location via a non-illustrated intervening electrical insulating film (FIG. 2(f)). Actually, the light blocking electrode 4 was formed by patterning an aluminum film to have a width of 10 μm and a length of 50 μm. Finally, the electrostatically chargeable colored fine particles 6 are placed over the light blocking electrode 4 and reflective film 7, and then the transparent front substrate 3A previously formed with the light blocking member 8 facing the light blocking electrode 4 is bonded to the transparent rear substrate 3B via non-illustrated spacers using adhesive (FIG. 2(g)). Actually, polymerized toner having a particle diameter of about 5 μm was used as the colored fine particles 6. The display device according to the present embodiment is completed through the fabrication process steps thus described.

The following description is directed to the principle of the displaying operation of the display device having the above-described construction using the colored fine particles 6.

First, a principle based on which the display device performs a displaying operation in the case where extraneous light is rich while the light source is off will be described with reference to the drawings.

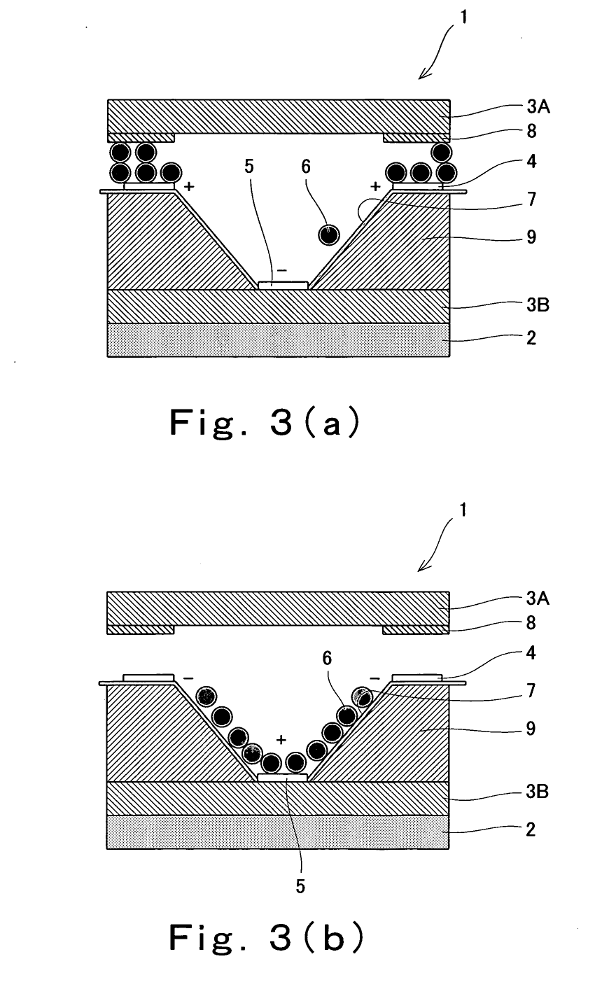

FIGS. 3(a) and 3(b) are schematic views illustrating a principle of operating a pixel of the display device according to the present embodiment. As shown in FIGS. 3(a) and 3(b), the display device according to the present embodiment is capable of gathering the colored fine particles 6 on the light blocking electrode 4 or around the transparent electrode 5 by application of potentials that are opposite to each other in polarity (positive or negative) to respective of the light blocking electrode 4 and the transparent electrode 5. For example, if the colored fine particles 6 are negatively charged, the colored fine particles 6 can be gathered on the light blocking electrode 4 as shown in FIG. 3(a) by rendering the potential of the light blocking electrode 4 positive and the potential of the transparent electrode 5 negative.

More specifically, when voltages were applied to respective of the light blocking electrode 4 and the transparent electrode 4 so that the potential of the light blocking electrode 4 and that of the transparent electrode 5 assumed +150V and −150V, respectively, the colored fine particles 6 gathered on the light blocking electrode 4 and remained little around the transparent electrode 5 as shown in FIG. 3(a). In this state the display device 1 displayed white because the reflective film 7 scatteringly reflected extraneous light while the light blocking members 8 hid the colored fine particles 6. On the other hand, when voltages were applied to respective of the light blocking electrode 4 and the transparent electrode 4 to generate an electric field in a direction opposite to that in the case of FIG. 3(a) as shown in FIG. 3(b), the colored fine particles 6 gathered to cover the transparent electrode 5 and the reflective film 7. Since the colored fine particles 6 had a light blocking property, extraneous light was not reflected by the reflective film 7 and, as a result, the pixel 1 displayed black when black particles were used as the colored fine particles 6. In this way the display device 1 is capable of displaying black or white by causing the colored fine particles 6 to travel appropriately in the case where extraneous light is rich while the light source is off. While this embodiment uses black colored fine particles, a similar embodiment is possible even when colored fine particles of red, green or blue are used.

The following description with reference to the drawings is made of a principle based on which the display device performs a displaying operation in the case where extraneous light is poor while the light source is on.

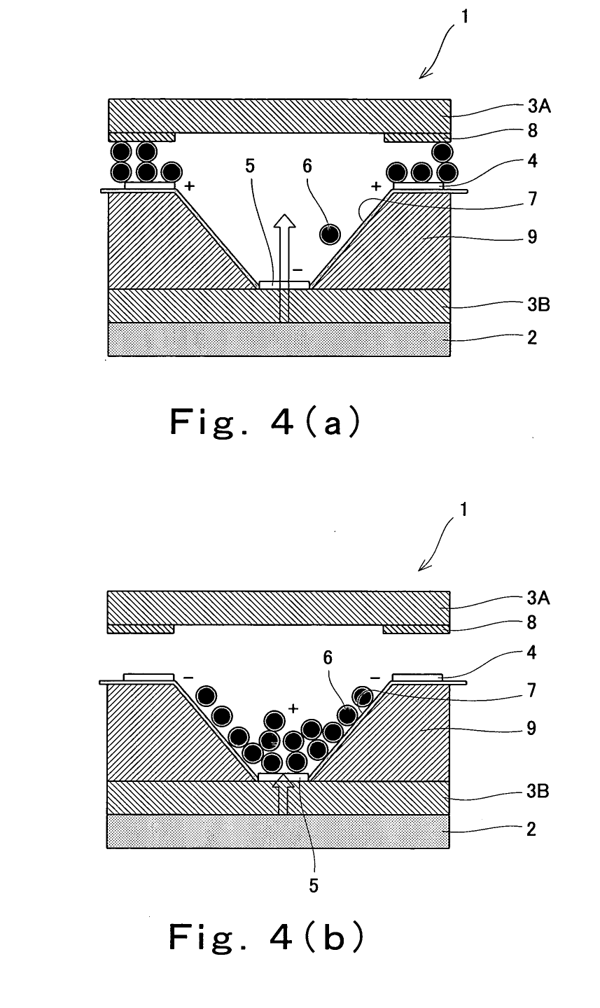

FIGS. 4(a) and 4(b) are schematic views illustrating another operating principle of the display device according to the embodiment 1 of the present invention. In an environment with poor extraneous light, the display device performs a displaying operation with the backlight 2 under the transparent rear substrate 3B being kept on. This displaying principle of the display device will be described with reference to FIGS. 4(a) and 4(b).

Referring to FIG. 4(a), when displaying white, the display device 1 generates a predetermined electric field between the light blocking electrode 4 and the transparent electrode 5 so as to cause the colored fine particles 6 to gather on the light blocking electrode 4. Specifically, the light blocking electrode 4 and the transparent electrode 5 are caused to assume a positive potential and a negative potential, respectively. At that time the colored fine particles 6 are mostly gathered on the light blocking electrode 4 with few particles remaining around the transparent electrode 5, white light emitted from the backlight 2 passes through the transparent electrode 5 without interference. That is, the observer views a white display. Referring to FIG. 4(b), on the other hand, when the light blocking electrode 4 and the transparent electrode 5 are caused to assume a positive potential and a negative potential, respectively, to generate a predetermined electric field between the light blocking electrode 4 and the transparent electrode 5, the colored fine particles 6 are caused to travel from the light blocking electrode 4 to cover the transparent electrode 5 and its periphery. As a result, the colored fine particles 6 cover the transparent electrode 5 and the reflective film 7 and, hence, white light emitted from the backlight 2 fails to pass through the transparent electrode 5. That is, the observer views a black display.

As described above, the display device according to the present embodiment is capable of displaying black and white clearly with satisfactory visibility by allowing extraneous light to be reflected in an environment with rich extraneous light while turning on the backlight in an environment with poor extraneous light. Since this embodiment has the transparent electrode 5 in the bottom of the depressed space defined between the uneven members 9, the colored fine particles 6 can be piled up to form a thick layer. This can contribute to an improvement in display contrast.

### Embodiment 2

Monochromatic display (black and white display for example) has been described in Embodiment 1. In Embodiment 2, description is made of the case where color display is realized by the use of the display device according to embodiment 1.

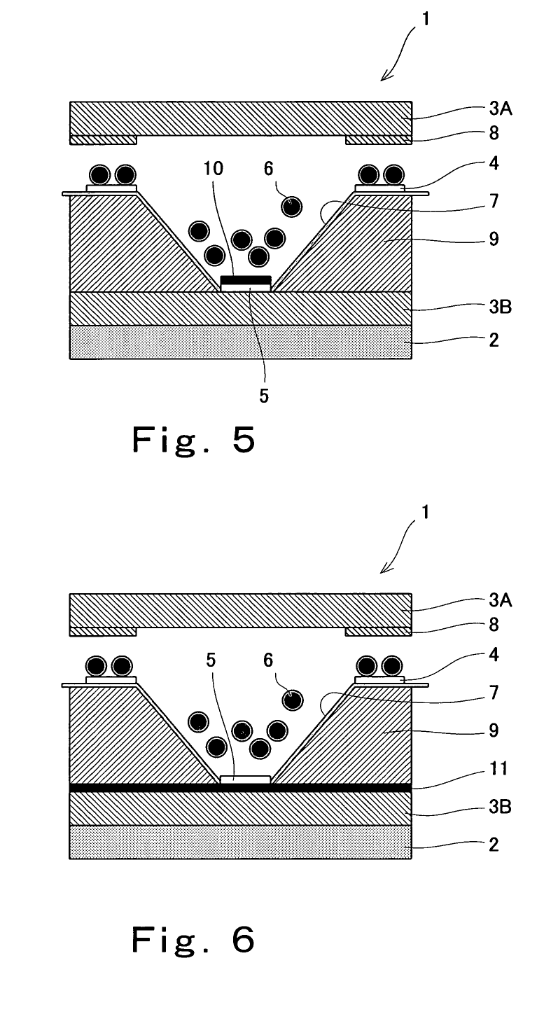

FIG. 5 is a sectional view schematically showing the construction of a display device according to embodiment 2 of the present invention.

As shown in FIG. 5, the display device 1 according to the present embodiment has backlight 2 operative to emit white light as a light source, transparent front substrate 3A and transparent rear substrate 3B, light blocking electrode 4, transparent electrode 5, electrostatically chargeable fine particles 6, reflective film 7, light blocking members 8, and uneven members 9. On the surface of the transparent electrode 5 is provided a red color filter 10 having a predetermined thickness and substantially the same shape as the transparent electrode 5. Other features are in common with the corresponding ones of embodiment 1.

Based on the same principle as in embodiment 1, pixel 1 of the above-described configuration generated a predetermined electric field between the light blocking electrode 4 and the transparent electrode 5 so as to cause the colored fine particles 6 to gather on the light blocking electrode 4. Further, the backlight 2 was turned on to emit white light. In this state the colored fine particles 6 mostly gathered on the light blocking electrode 4 and, hence, white light emitted from the backlight 2 passed through the transparent electrode 4 and then through the red color filter 10 used in this embodiment and became incident on the observer's eyes. Accordingly, the observer viewed a red display. Conversely, a predetermined electric field was generated between the light blocking electrode 4 and the transparent electrode 5 so as to cause the colored fine particles 6 to gather on and around the transparent electrode 5. Then, the colored fine particles 6 gathered on the transparent electrode 5 and the reflective film 7. Accordingly, white light emitted from the backlight 2 failed to pass through the transparent electrode 4 and the color filter 10 disposed on the upper side of the transparent electrode 4. That is, the observer viewed a black display. Thus, the present embodiment is capable of switching between a black display and a red display by causing the colored fine particles 6 to travel appropriately. If R, G and B color filters for red, green and blue are appropriately provided for respective pixels constituting display devices, a display apparatus capable of full color display can be constructed. It should be noted that in the case of display based on reflection of extraneous light, the display device is capable of displaying black and white based on the same display principle as in embodiment 1.

Variations of the present embodiment will be described.

First, description will be made of a first variation.

While the present embodiment is rendered capable of color display by forming the color filter 10 on the transparent electrode 5, a similar effect can be obtained if a color filter is formed on the transparent rear substrate 3B. Here, the first variation of the present embodiment is described with reference to the drawings.

FIG. 6 is a sectional view schematically showing the construction of the first variation of the display device according to embodiment 2 of the present invention.

As shown in FIG. 6, the first variation of the display device according to the present embodiment has a color filter 11 provided on the surface of the transparent rear substrate 3B. Other features are in common with the corresponding ones of embodiment 1. In the first variation having the aforementioned arrangement, white light emitted from the backlight 2 passes through the transparent rear substrate 3B, the color filter 11 and then the transparent electrode 5. Accordingly, the observer views light in the color (red, green or blue) of the color filter 11. That is, the first variation obtains a similar effect as can be obtained by the pixel 1 of the display device according to the present embodiment.

The next description is directed to a second variation of the present embodiment.

While the above-described first variation is rendered capable of color display by forming the color filter 11 on the transparent substrate 3, a similar effect can be obtained if a color filter is formed on the backlight 2. Here, the second variation of the present embodiment is described with reference to the drawings.

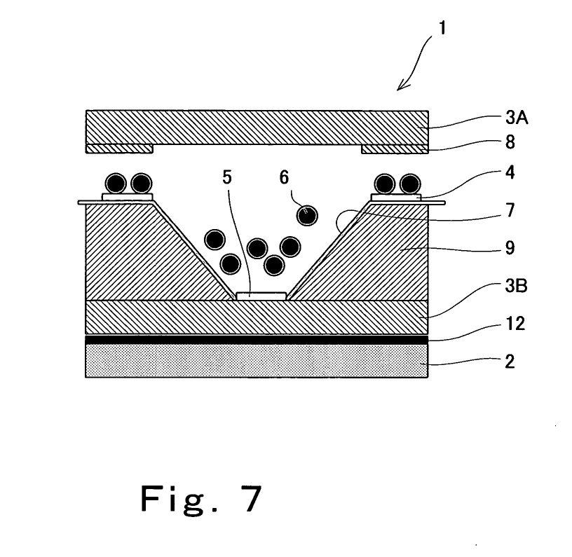

FIG. 7 is a sectional view schematically showing the construction of the second variation of the display device according to embodiment 2 of the present invention.

As shown in FIG. 7, the second variation of the display device according to the present embodiment has a color filter 12 provided on the light exit surface of the backlight 2. Other features are in common with the corresponding ones of embodiment 1. In the second variation having the aforementioned arrangement, white light emitted from the backlight 2 passes through the color filter 12, the transparent rear substrate 3B and then the transparent electrode 5. Accordingly, the observer views light in the color (red, green or blue) of the color filter 12. That is, this arrangement can obtain a similar effect as can be obtained by the pixel 1 of the display device 1 according to the present embodiment.

While the present embodiment uses the colored color filter to color light emitted from the backlight, it is also possible to realize color display by changing the color of light emitted from the backlight for each pixel to red, green or blue at fixed time intervals; that is, a similar effect as in the present embodiment can be obtained.

While the present uses polymerized toner having a particle diameter of 5 μm as the fine particles, an embodiment similar to the present embodiment is possible as long as the particles used therein are colored fine particles which can travel as desired by an electric field generated by voltage applied. Likewise, the present embodiment can be practiced as a display device using fine particles contained in a predetermined solvent filling the display device like an electrophoretic display device.

### Embodiment 3

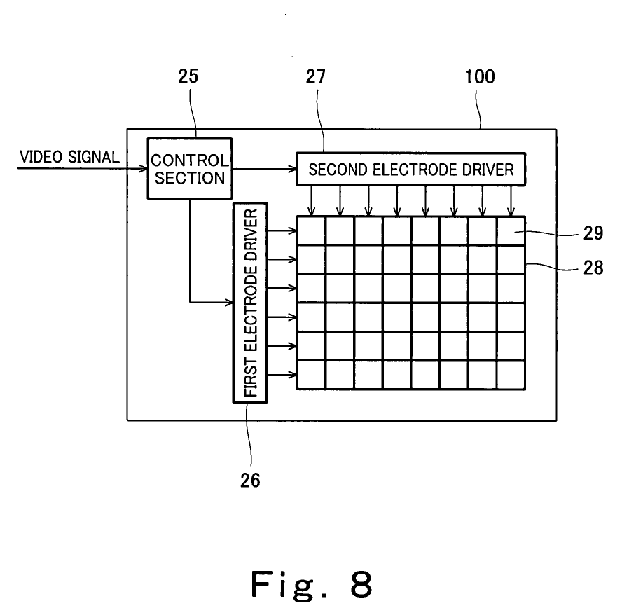

FIG. 8 is a block diagram showing the configuration of a display device according to embodiment 3 of the present invention.

As shown in FIG. 8, the display device 100 according to embodiment 3 includes a display section 28 having sub-pixels 29 arranged in matrix. Each of the sub-pixels 29 constituting the display section 28 has first and second electrodes, as will be described later. The first and second electrodes are connected to first and second electrode drivers 26 and 27, respectively. That is, each sub-pixel 29 is driven by the first and second electrode drivers 26 and 27. The operations of the respective first and second electrode drivers 26 and 27 are controlled by a control section 25 in accordance with video signals inputted to the control section 25. Thus, the display device 100 according to this embodiment comprises the control section 25, first and second electrode drivers 26 and 27, and display section 28 comprising the sub-pixels 29.

The following description is directed to the structure of the display section included in the display device according to embodiment 3 of the present invention.

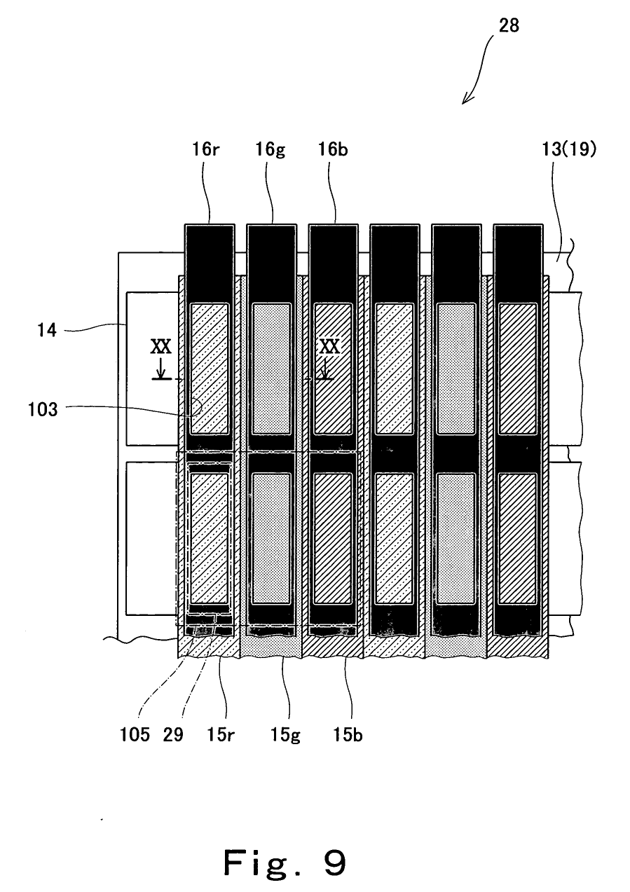

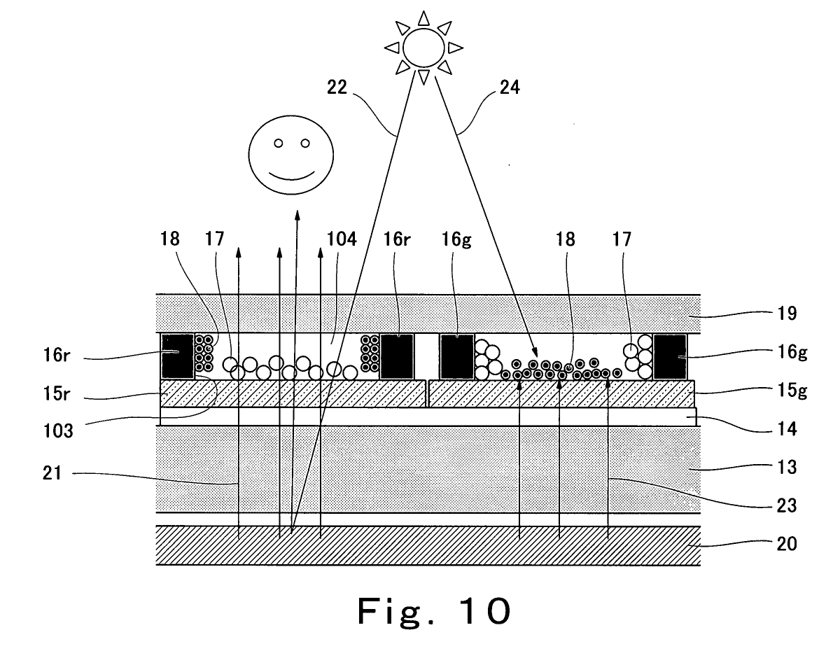

FIG. 9 is a fragmentary plan view schematically showing in a plan view a structure of the display section included in the display device shown in FIG. 8, while FIG. 10 is a fragmentary sectional view, taken along line XX-XX of FIG. 9, schematically showing a sectional structure of the display section included in the display device shown in FIG. 8.

As shown in FIG. 9, the display device of the present embodiment is capable of color display and has the display section 28 in which plural strip-shaped first electrodes (hereinafter will be referred to as row electrodes) 14 and plural strip-shaped second electrodes (hereinafter will be referred to as column electrodes) 16r, 16g and 16b are arranged to intersect each other perpendicularly in a plan view, the intersections of the first and second electrodes forming sub-pixels 29. The column electrodes 16r, 16g and 16b each define openings 103 in portions intersecting the row electrodes 14 (namely, in portions forming sub-pixels 29.) The column electrodes include the three types of electrodes: column electrode 16r for red, column electrode 16g for green, and column electrode 16b for blue. A set of the three types of electrodes is repeatedly formed in the direction of row. A set of sub-pixels formed at the intersections of each set of electrodes 16r, 16g and 16b and each row electrode 14 constitutes a pixel 105, which corresponds to a pixel of a display device adapted for black-and-white display.

As shown in FIGS. 9 and 10, the display section 28 has a transparent front substrate 19 and a transparent rear substrate 19, which are positioned to face each other. The rear substrate 13 has an inner surface formed with the row electrodes 14 on which are disposed color filters 15r, 15g and 15b each comprising a dielectric film. The color filters include the three types of color filters: color filter 15r for red, color filter 15g for green, and color filter 15b for blue. A set of the three types of color filters is repeatedly formed in the direction of row. Column electrodes 16r, 16g and 16b for respective colors are formed on color filters 15r, 15g and 15b, respectively. Transparent particles 17 and black particles 18 are accommodated within each opening 103 of each of the column electrodes 16r, 16g and 16b. The front substrate 19 is positioned over the column electrodes 16r, 16g and 16b, whereby the openings 103 are sealed to form hermetic spaces 104 (hereinafter will be referred to as sub-pixel spaces). Each of the sub-pixel spaces 104 has encapsulated transparent particles 17 and black particles 18 therein. Here, the sub-pixel spaces 104 are filled with air.

An EL backlight 20 is disposed behind the rear substrate 13. The EL backlight 20 is similar in configuration to that described in Embodiment 1.

The following description is directed to the summary of a fabrication method of the display device 100 thus constructed.

Referring to FIGS. 8 and 9, plural strip-shaped row electrodes 14 each comprising indium tin oxide (ITO) and having a width of 210 μm and a thickness of 100 nm were formed on one main surface of rear substrate 13 comprising a transparent resin such as polycarbonate resin or polyethylene terephthalate resin by vapor deposition and photolithography. Thereafter, the row electrodes 14 were coated with transparent resist resins each containing a color pigment dispersed therein, and then each of the resulting resist coats was patterned into a stripe by photolithography, thus forming red, green and blue color filters 15r, 15g and 15b having a thickness of about 2 μm.

Subsequently, copper plating was conducted on the rear substrate 13 formed with the color filters 15r, 15g and 15b using a resist pattern formed by photolithography as a mask to form plural sets of column electrodes 16r, 16g and 16b. Openings 103 were formed in respective of predetermined portions of each of the column electrodes 16r, 16g and 16b. The column electrodes 16r, 16g and 16b were formed at a pitch of 70 μm and each had a width of 60 μm. The width of each opening 103 was 40 μm.

Subsequently, spherical transparent particles 17 of acrylic resin having a particle diameter of 10 μm and spherical black particles 19 having a particle diameter of 5 μm which had been rendered negatively chargeable (toner for electrophotography in this embodiment) were sprayed into the openings 103 of the column electrodes 16r, 16g and 16b. Specifically, transparent particles 17 and black particles 18 were premixed at a weight ratio of 1:1 and stirred sufficiently, so that transparent particles 17 and black particles 18 were electrostatically charged positively and negatively, respectively. Powder comprising transparent particles 17 and black particles 18 was sprayed into the openings 103 of the column electrodes 16r, 16g and 16b within an airtight enclosure using an air gun.

In turn, UV-setting adhesive was applied to a thickness of about 10 μm to regions of one main surface of front substrate 19 comprising a transparent film (having a thickness of 50 μm) of the same material as the rear substrate 13 by screen printing, these regions coinciding with the column electrodes 16r, 16g and 16b. The substrate 19 was brought into close contact with the column electrodes 16r, 16g and 16b and then the adhesive was set by ultraviolet-light irradiation. Thus, transparent particles 17 and black particles 18 were encapsulated within each of the sub-pixel spaces 104 defined by the color filters 15r, 15g and 15b, column electrodes 16r, 16g and 16b and the substrate 19, and the display panel was completed.

Subsequently, the first and second electrode drivers 26 and 27 were mounted on the periphery of this display panel and the EL backlight 20 mounted behind the display panel. Thus, the display device 100 according to the present embodiment was completed.

The following description is directed to a displaying principle of the display device according to embodiment 3 of the present invention.

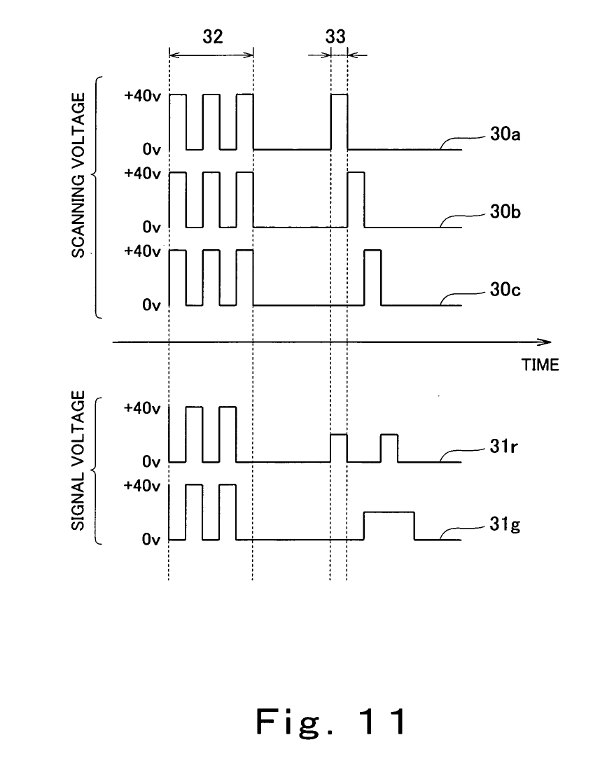

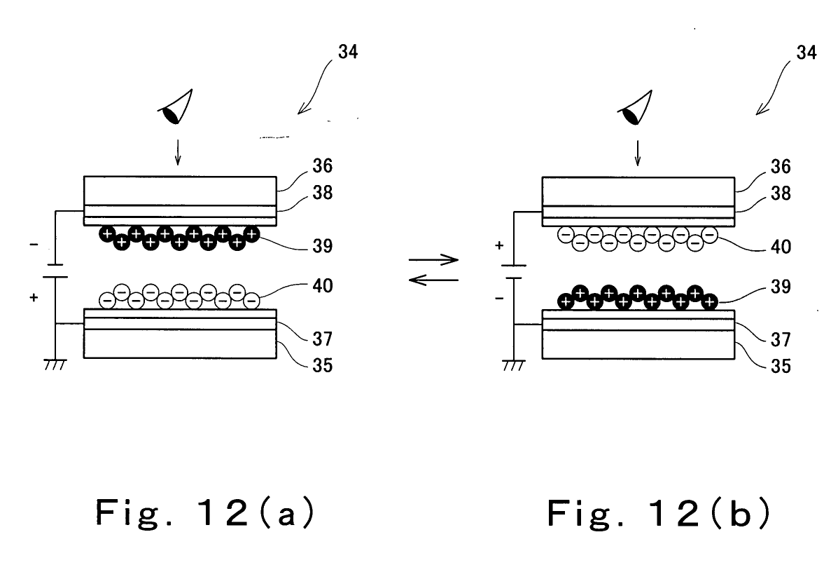

FIG. 11 is a driving waveform chart schematically showing driving waveforms for driving the display device according to embodiment 3 of the present invention.

In the display device 100 the first and second electrode drivers 26 and 27 apply driving voltages having respective waveforms shown in FIGS. 11(a) and 11(b) to the display section 28 under control of the control section 25. In FIG. 11, curves 30a, 30b and 30c plot changes with time of scanning voltages for selecting the row electrodes 14 sequentially after a reset period. Specifically, the curve 30a plots a change with time of voltage applied to the row electrode 14 shown in FIGS. 9 and 10, while the curves 30b and 30c plot changes with time of voltages applied to the next row electrode 14 and the next to next row electrode 14. Curves 31r and 31g plot changes with time of signal voltages applied to the column electrodes 16r and 16b synchronously with the scanning voltages shown in FIG. 11. For the sake of convenience, description of other row electrodes and column electrodes than shown in FIG. 9 will be omitted.

During the reset period 32, all the row electrodes 14 of the display device 100 were simultaneously applied with voltage assuming +40 V and 0 V alternately three times repeatedly by the first electrode driver 26, while at the same time the column electrodes 16r and 16g applied with voltage assuming 0 V and +40 V alternately by the second electrode driver 27. By so doing, a particulate material layer comprising transparent particles 17 and black particles 18 was applied with alternating voltage of +−40 V. In sub-pixel space 104 of the column electrode 16r shown in FIG. 10 for example, black particles 18 traveled toward and adhered to sidewalls of the column electrode 16r then. Transparent particles 17, on the other hand, became dispersed over the color filter 15r. After the sub-pixels had been thus reset, a selection pulse voltage of +40 V, a voltage of +20 V and a voltage of 0 V were applied to row electrode 14, column electrode 16r and column electrode 16g, respectively, during a row electrode selection period 33, as shown in FIG. 11. At that time, the potential of the row electrode 14 became 20 V positive relative to that of the column electrode 16r in the sub-pixel space 104 of the column electrode 16r. Accordingly, positively charged transparent particles 17 became adhering to the row electrode 14 assuming a relatively positive potential via the color filter 15r, whereas negatively charged black particles 18 became adhering to the column electrode 16r assuming a relatively negative potential. Though, naturally, electrostatic repulsive force was exerted on both black particles 18 and transparent particles 17 from the electrodes 16r and 14 to which they were adhering directly or indirectly, the force causing black particles 18 and transparent particles 17 to adhere to the respective counterpart members overcame the electrostatic repulsive force because the potential difference between the row electrode 14 and the column electrode 16r was as relatively small as 20 V. Thus, the reset state of the sub-pixel space 104 of the column electrode 16r was kept as it was. When the observer viewed the sub-pixel in this state from the front side (front substrate 19 side) as shown in FIG. 10, the sub-pixel was confirmed to display a red color which was the color of the color filter 15r because extraneous light passing like arrow 22 reached the main surface of the EL backlight 20 and reflected by the surface of the backlight 20. When the backlight 20 was turned on, the sub-pixel shone red because light emitted from the EL backlight 20 passed like arrow 21. Note that when the display device 100 of this embodiment was modified for black-and-white display, the sub-pixel was observed to display the background color (the color of the EL backlight 20); that is, the sub-pixel displayed white.

In sub-pixel space 104 of the column electrode 16g, on the other hand, the potential of the row electrode 14 became 40 V positive relative to that of the column electrode 16r to provide a relatively large potential difference between the row electrode 14 and the column electrode 16r. Accordingly, the electrostatic repulsive force from the electrodes 16r and 14 to which black particles 18 and transparent particles 17 were adhering directly or indirectly overcame the force causing black particles 18 and transparent particles 17 to adhere to the respective counterpart members, so that the transparent particles 17 and the black particles 18 were transposed from each other as shown in FIG. 10. That is, the black particles 18 became dispersed over the color filter 15g, with the result that both extraneous light 24 and illuminating light 23 emitted from the EL backlight 20 were absorbed by the group of black particles 18. Thus, the sub-pixel displayed black not only by the reflective display operation but also by the transmissive display operation.

By thus providing the selection period 33 after the reset period 32 in each video signal frame as shown in FIG. 11, scanning voltages and signal voltages as shown in FIG. 11 can be inputted to the display section 28 to display an image according to the video signal.

The contrast of the image displayed at that time was about 15:1. The opening portion of a cell not provided with a color filter (in the display device 100 of the present embodiment modified for black and white display) could exhibit a high reflectance, which was higher than 70%. By virtue of the transparent particles 17 and black particles 18 traveling in the gaseous phase, the display device’ response to the video signal was as fast as or faster than 1 msec. Further, the display state of each sub-pixel was maintained even after powering off, which confirmed that each sub-pixel had memory capability.

According to the present embodiment the transparent particles 17 are used to utilize reflection of light at the reflective member (specifically, the main surface of the EL backlight 20 in FIG. 10) behind the transparent particles 17. For this reason, this embodiment can easily enhance the reflectance during the white display operation as compared to the conventional device using white particles. Such white particles as used in the conventional display device to display white comprise a resin such as an acrylic resin and inorganic crystal of high reflectance, such as titanium oxide, dispersed in the resin and cause light to scatter due to the difference in refractive index between the resin and the inorganic crystal. Scattering of light is caused repeatedly among a large number of such white particles. For this reason, the conventional display device using such white particles is required to have a white particle layer as thick as about 50 to about 100 μm in a cell in order to obtain a reflectance not lower than 60%, which is comparable to the reflectance of newspaper for example. Such a thick white particle layer exhibits a high resistance to traveling of particles and hence makes particles to difficult to travel. Further, the thick particle layer requires an increased cell thickness (the spacing between the front substrate 19 and the rear substrate 13) and, hence, proper and accurate traveling of particles cannot be ensured unless a considerably high voltage (about 300 V for example) is applied. Black particles, on the other hand, absorb light effectively by black dye, carbon black or the like present in each of the particles and hence are capable of displaying black even when layered relatively thin. Specifically, a black particle layer having a thickness as small as about 5 μm is capable of absorbing not less than 90% of light. According to the present embodiment, the group of black particles 18 each having a diameter of 5 μm is encapsulated in an amount slightly larger than required to form a single ply in order to fill gaps. Such a thin black particle layer realizes a sufficiently lowered black level.

In the conventional display device using black particles and white particles, it is difficult to reduce the pixel pitch to 100 μm or smaller because of the cell thickness as large as 100 to 300 μm. In contrast, the display device 100 according to the present embodiment is capable of significantly lowering the driving voltage to 40 V while reducing the pixel pitch to 70 μm or smaller to realize high resolution.

Since the present embodiment uses the transparent particles 17, transmissive display using the EL backlight 20 is possible. Such transmissive display ensures satisfactory visibility even in a dark room with poor extraneous light and is capable of color display.

In the present embodiment transparent particles 17 and black particles 18 coexist. In the case where only negatively chargeable black particles for example were charged negatively by agitation with ferrite or the like and then encapsulated, the black particles traveled a little even under application of voltage and then became nearly immobile. Conceivably, this is because the amount of electrostatic charge decreased gradually due to the use of the black particles only. When two or more types of particles made from different materials travel as in the present embodiment, they are electrostatically charged by mutual contact or friction. With use of only a single type of particles, however, it is considered that they are electrostatically charged only by their contact with the substrates and hence discharge mainly during their travel. For this reason, traveling of the particles becomes difficult. Thus, colored particles (black particles 18) and transparent particles (transparent particles 17) need be opposite in polarity when charged and have different optical properties. As long as colored particles and transparent particles have such properties, each of the colored particle group and the transparent particle group may comprise different kinds of particles, though the present embodiment uses a single kind of particles for each group of particles.

While the present embodiment is capable of both transmissive display and reflective display by allowing extraneous light passing through the group of transparent particles 17 to be reflected by the main surface of the EL backlight 20, bright white display of the reflective type is possible if each row electrodes 14 is formed from a reflective material such as aluminum because extraneous light passing through the group of transparent particles 17 is reflected by the row electrode 14 and then scattered upon their re-passage through the group of transparent particles 17.

While the present embodiment realizes color display by using color filters, color display like the present embodiment is possible by using either a combination of differently colored particles and transparent particles or a combination of differently colored transparent particles and black particles.

The display device 100 according to the present embodiment has the rear substrate 13 comprising a resin substrate formed from a transparent resin such as polycarbonate resin or polyethylene terephthalate resin. Instead of such a resin substrate, a glass substrate for example may be used for the rear substrate 13. A display device having such a feature can exhibit such capabilities as fast response capability and memory capability, like the display device 100 of the present embodiment. However, the use of a flexible thin resin substrate provides the advantage that the display device 100 can be easily formed because the display device 100 of the present embodiment has a cell thickness as large as several tens of micrometers as compared to the cell thickness of a liquid crystal display device and does not need the provision of an active matrix, which is difficult to form on a resin substrate. That is, it is possible to realize a highly portable mobile device including a very thin and unbreakable sheet-type display device.

### Embodiment 4

Embodiment 4 of the present invention is an application of the display device of embodiment 1 to a display device having plural pixels.

The display device of the present embodiment has an electrical configuration as shown in the block diagram at FIG. 8.

Each of the pixels 29 is structured as shown in FIG. 1, and light blocking electrode 4 is connected to first electrode driver 26 while transparent electrode 5 connected to second electrode driver 27. Light blocking member 8 is formed in a matrix so as to extend along the border between adjacent pixels 29.

The operation and the fabrication method of the display device thus configured according to the present embodiment are similar to those described in embodiment 1. The configuration according to the present embodiment can enjoy the same advantage as embodiment 1.

It will be apparent from the foregoing description that many improvements and other embodiments of the present invention occur to those skilled in the art. Therefore, the foregoing description should be construed as an illustration only and is provided for the purpose of teaching the best mode for carrying out the present invention to those skilled in the art. The details of the structure and/or the function of the present invention can be modified substantially without departing from the spirit of the present invention.

### INDUSTRIAL APPLICABILITY

The display device and the driving method thereof according to the present invention are useful as a particulate material utilizing display device which offers a satisfactory color reproducible range without its visibility being degraded even in a dark environment with poor extraneous light, and a driving method thereof.

1. A display device comprising a pair of opposite substrates, a group of electrostatically chargeable colored particles present between the pair of substrates, a transparent first electrode, and a second electrode, wherein
the group of colored particles is capable of traveling in a manner to or not to shut off light incident on or passing through the first electrode in accordance with voltage applied across the first and second electrodes for displaying an image.

2. The display device according to claim 1, which has a light source for emitting the light.

3. The display device according to claim 1, wherein the group of colored particles is capable of traveling so as to be displaced in a plan view in a manner to or not to shut off the light.

4. The display device according to claim 2, which has a color filter operative to permit light from the light source to pass therethrough for color display.

5. The display device according to claim 4, wherein the color filter is disposed on a surface of at least one of the pair of substrates.

6. The display device according to claim 4, wherein the color filter is disposed on a surface of the first electrode.

7. The display device according to claim 4, wherein the color filter is disposed on a light exit surface of the light source.

8. The display device according to claim 2, wherein the light source is configured to emit any one of red light, green light and blue light on a time-sharing basis.

9. The display device according to claim 2, wherein the light source is configured to emit light only for color display.

10. The display device according to claim 1, wherein at least one of the pair of substrates comprises a resin film.

11. The display device according to claim 1, which has a reflective plate for reflecting light which is operative to reflect incident extraneous light for displaying white.

12. The display device according to claim 11, wherein the reflective plate has a light scattering property.

13. The display device according to claim 1, wherein: the pair of substrates are both transparent; one of the substrates has an inwardly oriented surface formed with a projecting-depressed member defining a depression and a pair of projections on opposite sides of the depression; and the first electrode is formed on a bottom portion of the depression, while the second electrode formed on top portions of the pair of projections.

14. The display device according to claim 13, wherein: the projections and the pair of depressions define border portions therebetween, each of the border portions being shaped into a sloped surface; a surface extending from the sloped surface to the top portion of each of the projections is formed with a light reflective plate; and the second electrode is formed on the light reflective plate.

15. The display device according to claim 14, wherein the second electrode is formed on the reflective plate with an insulator intervening therebetween.

16. The display device according to claim 1, wherein the pair of substrates define therebetween a space in a gaseous phase.

17. A method of driving a display device including a pair of opposite substrates, a group of electrostatically chargeable colored particles present between the pair of substrates, a transparent first electrode, and a second electrode,
the method comprising applying voltage across the first and second electrodes to cause the group of colored particles to travel in a manner to or not to shut off light incident on or passing through the first electrode in accordance with the applied voltage for displaying an image.

18. The method according to claim 17, wherein the display device has a light source for emitting the light, the light source being configured to emit any one of red light, green light and blue light on a time-sharing basis.

19. The display device according to claim 1, further comprising a group of transparent particles present together with the group of colored particles between the pair of substrates, the group of transparent particles being electrostatically chargeable to have a polarity opposite to that of the colored particles, wherein
the group of colored particles and the group of transparent particles are capable of traveling between the first and second electrodes so as to transpose each other in a manner to or not to shut off light incident on or passing through the first electrode in accordance with voltage applied across the first and second electrodes for displaying an image.

20. The display device according to claim 19, which has a light source for emitting the light.

21. The display device according to claim 19, wherein the group of colored particles and the group of transparent particles are capable of traveling so as to be displaced in a plan view in a manner to or not to shut off the light.

22. The display device according to claim 19, wherein when the group of transparent particles occupies substantially an entire area of a pixel in a plan view, a reflective member located behind the group of transparent particles reflects extraneous light to display white.

23. The display device according to claim 19, which has a color filter operative to permit the light to pass therethrough for color display.

24. The display device according to claim 20, wherein when the group of transparent particles occupies substantially an entire area of a pixel in a plan view while occupying a major plane of the pixel, a reflective plate located behind the light source or a scattering plate located in front of the light source reflects extraneous light to display white.

25. The display device according to claim 20, wherein the light source is configured to emit any one of red light, green light and blue light on a time-sharing basis.

26. The display device according to claim 20, wherein the light source is configured to emit light only for color display.

27. The display device according to claim 19, wherein at least one of the pair of substrates comprises a resin film.

28. The display device according to claim 19, wherein: the pair of substrates are both transparent; the first electrode in a film form, an insulating film and the second electrode in a film form and having an opening are positioned in this order between the pair of transparent substrates; and the group of colored particles and the group of transparent particles are encapsulated in the opening of the second electrode.

29. The display device according to claim 28, wherein the insulating film is a color filter.

30. The display device according to claim 29, which has a light source for emitting the light which is located externally of the substrate positioned closer to the first electrode.

31. The display device according to claim 19, wherein each of the transparent particles has a larger diameter than each of the colored particles.

32. The display device according to claim 19, wherein the pair of substrates define therebetween a space in a gaseous phase.

33. The method according to claim 17, wherein the display device further comprises a group of transparent particles present together with the group of colored particles between the pair of substrates, the group of transparent particles being electrostatically chargeable to have a polarity opposite to that of the colored particles,
the method comprising applying voltage across the first and second electrodes to cause the group of colored particles and the group of transparent particles to travel between the first and second electrodes so as to transpose each other in a manner to or not to shut off light incident on or passing through the first electrode in accordance with the applied voltage for displaying an image.

34. The method according to claim 33, wherein the light source is configured to emit any one of red light, green light and blue light on a time-sharing basis.
